(19) United States
(12) Patent Application Publication
(10) Pub. No.: US 2006/0163492 A1
(43) Pub. Date: Jul. 27, 2006

(54) Method for encoding items of information and a device and method for evaluating the encoded information

(75) Inventors: Guido Mennicken, Julich (DE); Harry Vereecken, Julich (DE)

Correspondence Address: THE FIRM OF KARL F ROSS, 5676 RIVERDALE AVENUE, PO BOX 900, RIVERDALE (BRONX), NY, 10471-0900, US

(73) Assignee: FORSCHUNGSZENTRUM JULICH GMBH, D-52425 JULICH (DE)

(21) Appl. No.: 10/534,548

(22) PCT Filed: Oct. 9, 2003
(86) PCT No.: PCT/DE03/03353

§ 371 Date: May 3, 2005

(30) Foreign Application Priority Data
Nov. 11, 2002 (DE) 102 52 628.1

(51) Int. Cl. G01J 1/58

(52) U.S. Cl. 250/483.1

(57) ABSTRACT

The invention relates to a method for encoding items of information and to a device and method for evaluating the encoded information. A prior art method for marking and providing objects with items of information and data involves the creation and use of bar code. With the inventive method, it is now possible to provide objects with a more sophisticated and higher data density than that provided by prior art methods. By using fluorescent dyes, an additional encoding word is added to the coding language, this coding language having been available up to now and being composed of a sequence consisting of black and white bars, thereby increasing the depictable data density. The inventive device enables the decryption of encrypted and compressed items of information, which have a higher data density than that of prior art encoding methods. To this end, an opto-electrical reading unit is equipped with means that control the emission of light.

The invention relates to a method of coding information as well as to a device and method for evaluating the coded information.

A method of providing objects with information and data and thereby identifying such objects is the application and use of bar codes.

The bar code is comprised of a sequence of wide and narrow bars and wide and narrow gaps. The sequence of these bars and gaps represents in coded form the information which, as a rule, is alphanumeric. The bars and gaps are normally provided in a ratio (small:wide) of 1:2 to 1:3. These dimensions enable reliable optoelectrically interpretable readable signals to be produced practically independently of the quality of the printing technique used to apply the bar code. Depending upon the desired information density, information content and/or reading speed various purely numerical or also alphanumerical codes can be used.

These bar codes can be decoded with corresponding optoelectronic reading devices working contactlessly to identify the objects from the applied information which is keyed to the object and in compressed form. These reading devices are comprised basically of a light source, like for example an LED or a laser, whose light beam, for example by a radiating polygonal mirror is scanned over the bar code. The different reflections from the bar code and its background, in the form of an intensity modulated received beam is evaluated and decoded by means of a detector. Reading pens operate mainly with red or infrared (IR) light. What is measured is the intensity of the reflected light resulting from the dark and light strips. The displayable or keyed information density of the bar codes previously known is limited since the display of the information is only possible through the sequence of the “code words” in the form of wide and narrow strips. A further disadvantage of previously known bar codes resides in that a complete or supplemental encoding of further information upon objects with additional bar codes can give rise to confusion and errors in the reading or decoding of the information.

It is thus the object of the invention to provide a method with which it is possible to apply a higher data density to articles than with hitherto used coding methods. It is further the object of the invention to provide a method and a device with which a rapid, precise and easily handled evolution of information can be effected and which can be applied to articles with an increased data density.

Starting from the preamble of claim 1, the objects are achieved in accordance with the invention with the features given in the characterizing part of claim 1. Further, the objects are achieved starting from the preamble of claim 13 in accordance with the invention with the features given in the characterizing part of claim 13. In addition, starting from the preamble of claim 21, the objects of the invention are achieved by the features given in the characterizing part of claim 21.

With the method according to claim 1 and in accordance with the invention it is possible directly to obtain articles with a higher data density and thus differentiated from methods which have hitherto been known for applying data to such articles.

With the method according to the invention it is moreover possible to provide objects in a simple manner with information and, in addition, to apply such information as may be required subsequently to the objects. With the device according to the invention and according to claim 13 and the method according to claim 21 it is directly possible to decode information in an evaluation step and which has a higher density by comparison with hitherto known coding methods.

Advantageous further features are given in the dependent claims.

The object of the invention is a method according to claim 1 for the coding of information on objects through use of florescent dyestuffs.

The term “coding” should be understood in the framework of the present invention as well as with respect to the encoding of information, as to be in the form of a bar code which is made with fluorescent dyes or in which fluorescent dyes are used in combination with hitherto known bar codes and thus encompasses a marking of the objects with fluorescent dyes as well as with a bar code. A marking of articles with fluorescent dyes can have the form of dots, bars, squares, triangles or other optically evaluatable patterns and geometric shapes. It can for example however also encompass the dyeing of the entire article with fluorescent dye stuffs. The fluorescent signal of the dyes or a combination of a plurality of dyes can provide information as to the object, like for example, information as to a particular material of the object, the price, functional features, specific identification, manufacture or preparation location or origin of a package or packed product.

Fluorescent dyes emit fluorescent light when they are irradiated with light which is capable of exciting fluorochromic molecules. Many fluorochromes (a collective designation for fluorescent dyes) have aromatic ring structures or characterizing double binding. Such molecules can have delocalized electrons in so-called binding π orbitals. The electrons of these orbitals participate readily in exchange with the environment and reach higher orbital (π*) upon absorption of an exciting photon. In binding orbitals the electrons normally are present with antiparallel spin which characterizes the so-called singlet state (S₀, S₁, S₂) The absorption of an exciting photon (hυ_{A}) lifts an electron from the ground state S₀ into one of the excited states S₁ or S₂. This process is extremely rapid and is complete within about 1 to 200 nanoseconds. An evolution or decoding of the information on the article is therefore possible with a very rapid reaction time. From the above excited state, a transition through S₁ is possible without emission of photons (“internal transformation”), although upon the transition into the ground stating, the energy liberated is emitted as a fluorescence photon (hυ_{F}). The energy of the emitted photon is always less than that of the absorbed photon and thus the wavelength of the fluorescent light is greater than of the exciting light (Stokes law). The mean residence time in the excited state (fluorescence light) is in the range of 10 nanoseconds with many fluorochromes. The fluorochromes (for example pyrene compounds, uranine compounds, quinine, fluorescein, rhodamine, acridine orange, tetracycline, porphyrine) provide even in small concentrations a strong fluorescence for the dyed objects or materials. If the emitted radiation is in the visible or close to the visible range of the spectrum, one can refer to it as optical fluorescence to distinguish it from the x-ray upon excitation.

The number of inorganic compounds with significant fluorescence is relatively small. Mainly organic materials are used as fluorescing compounds. Fluorescing dyes are used in spectroscopy to investigate and detect atoms and molecules. As the light source for excitation, lasers are increasingly used in addition to lamps.

Fluorescent dyes which fluoresce strongly in daylight and/or in ultraviolet light are used for the production of fluorescent stamps, for advertising printing using silk-screen methods and the coloring of plastics and paints. For this, so-called daylight colors, especially acridine, xanthene (for example fluorescein, rhodamine) thioxanthene and also pyrene, uranine or quinine can be used.

Since the fluorescing dyestuff emits light over a wide range of wavelengths from 300 to 1800 nm, it is possible to select the desired fluorescent dye based upon requirements, for example to have no fluorescence in the visible wavelength range and thereby enable the coding of information as one which cannot be detected by the human eye. This can then be important when optical coding is to be part of the use of the object, for example, allowing a sight window or other mark which is otherwise secretly placed, to be read or detected.

Further it is possible to use different fluorescent dyes simultaneously for coding with the consequence that a greater and more differentiatable content of information per unit area can be applied. With the use of black-white bars, the information can be differentiated only by the black and white coloration and the characteristics of the bars in the coding. With the use of different fluorescent dyestuff the respective characteristic fluorescence of the dyestuff can provide a further “coding word”.

With the use of different fluorescent dyes simultaneously, it is advantageous that these dyes differ only slightly in their absorption characteristics so that the excitation can be carried out with only one light source which, for example, emits light in the wavelength range of 250 to 400 nm and can excite all of the dyestuffs used. The resulting fluorescent peaks or fluorescent signals for the individual dyestuffs should, however, be so clearly different from one another that an identification is possible of each of the dyestuffs by these peaks and fluorescence signals so that for example, with a spectrometer the individual signals can be reliably identified. The fluorescent peaks of the different dyestuffs, therefore, in an optimum case should differ from one another so significantly that between the individual peaks the base line is again reached, thereby ensuring a clear evaluation of the code.

The dyestuffs can be applied in a desired pattern or the desired shape to the article. In an especially advantageous embodiment of the invention, the fluorescent dyestuffs are applied in the form of bar codes to the article. In the formation of bar codes with the fluorescent dyestuffs, it is possible to apply them to the locations of the previously used black imprints for the black-white bar code and during the printing process or in addition to the black-white bar codes, i.e. in place of or addition to the latter. Thus it is, for example, possible to introduce the fluorescent dyestuff into the print cartridge of a commercial printer with which the requisite bar code labels are printed. Depending upon whether only a fluorescent dyestuff or both a fluorescent dyestuff and a black printing ink is used for producing the bar code, the identification requirement can be satisfied. Through use of the fluorescent dyestuff as an additional “code word”, the information density is increased in an advantageous manner and it is also possible to complete the information subsequently where a black and white bar code has previously been applied without the danger that the previous bar code will be rendered ineffective.

In a further advantageous embodiment, a fluorescent dye is used which in daylight cannot be detected by the human eye, that is will not fluoresce in the spectral range of about 400 to 700 nm. This fluorescent dyestuff is appropriate for inconspicuous coding of information on articles. This can play an important role in the coding of information on, for example, viewing windows or windshields since invisible bar codes do not disturb the viewing properties through such windows but can provide information which can be evaluated, for example, during a sorting process.

The marking of articles with fluorescent dyes can be incorporated, in an advantageous embodiment of the method, in the fabrication process for such articles. Thus the fluorescent dyestuff can be applied, for example, during the painting of automotive vehicle body parts. They can, in addition, be incorporated during the production of synthetic resins, in the polymerization or polycondensation processes. Furthermore, the entire surface or the entire material of the article can contain a fluorescent dye, for example, in a sorting process to enable evaluation of the fluorescent signals independently of the positioning of the article. It is thus possible to protect articles against falsification and against damage to the coding by mechanical forces which, like rubbing actions, can affect markings which could be rubbed off during use of the article and which can carry desired information.

The method of the invention is especially suitable for the marking of articles which are intended to be subject to recycling systems, body parts or chassis parts of vehicles which must be sorted during the production process, inconspicuous markings on products whose design might be detrimentally affected by the application of hitherto known bar codes as well as markings which can protect against falsification of objects like for example tariff or customs seals.

The subject of the invention is, in addition, a device according to claim 12 for evaluating coded information on articles which have been encoded by means of fluorescent dyestuffs and including at least one light source and at least one detector, characterized in that the light source and detector are arranged in a reading head or a detection chamber and wherein the device contains means for controlling the light emission. With the device according to the invention information which is coded through the use of fluorescent dyestuffs can be specifically evaluated. It is also possible to evaluate information which has been coded through use of hitherto known bar codes in the form of narrow and wide black strips and spaces together with information coded with the fluorescent dyestuffs. With means of the invention for controlling the light emission, emission spectrums of a light source can be controlled within the wavelength range and for example 200 to 1800 nm for selective individual wavelengths, thereby splitting spectral lines or wavelength ranges. This can be achieved for example by the use of a spectral lamp whose mean spectrum is controlled by means of prisms or polygonal mirrors. Alternatively, different light sources can be used, such as LEDs, UV lamps, infrared light lamps or lasers which can be switched independently of one another and each of which emits a device-specific wavelength spectrum and thus also allows a control of the light emission. Through the emission only of a certain wavelength or a certain wavelength range of 10 to 20 nm, specific fluorescent dyestuffs can be selectively excited and thus can generate fluorescent signals characteristic of the dyestuff. Since each fluorescent dyestuff can be excited by a specific wavelength, each fluorescent dyestuff can serve to give specific information and by the time-spaced switching of light sources and corresponding synchronized detecting can be decoded. The information which has been coded by means of the different fluorescent dyes and the coded information of the black-white bars can thus be read specifically with the aid of the device according to the invention.

Objects which, for example in a recycling basis or in the framework of a fabrication process, which requires transport by containers or involve package transport in airports or allow letter sorting to respective target locations, can be effectively handled with the system of the invention. In attempted sorting apparatus, the objects are fed by a traveling belt passed the device which reads the information.

The detection chamber according to the invention includes a chamber into which the object to be evaluated can be completely fed and received, the information evaluated and the object further transported to the corresponding target location. A manual introduction of the object into the detection chamber is also possible.

Within the detection chamber, for example, one to five different light sources can be provided. It is however also possible to use for example 20 to 30 light sources (for example LEDs) with which a broad spectrum of different wavelengths can be used for excitation of the different fluorescent dyestuffs. The number of light sources is therefore dependent upon the requisite wavelength spectrum, the lamp-specific emission spectra and the requirement for different energy-rich radiation so that the number of light sources should not be limited to a specific number. Thus it is for example possible by means of a single light source, whose emission spectrum can be subdivided into the corresponding number of required wavelength regions, for example by a prism, filters or change of voltage, to specifically evaluate the information.

Under the term “detection chamber” a polygonally or spherically shaped space should be understood in which the object can be placed for evaluating the information. The internal surfaces are equipped with at least one light source and at least one detector.

In an advantageous configuration of the device, the detecting chamber is shielded against stray light. For the evaluation of the information which is coded by the fluorescent dyestuff, it has been found to be especially suitable to configure the device so that there is an indirect excitation with energy-rich which is reflected from the surfaces of the shielded detection chamber and surfaces to excite the fluorescent dyestuff on the subject of fluorescence. Thus, independently of the position or positions of the coded information around the object, the fluorescence signals can be evaluated without the need to have the object oriented in a direct light beam from the light source. Information which can be applied to different regions of the object can therefore be evaluated in a single evaluation step without orienting the object with respect to the light source and detector. The detection chamber shielded against foreign light ensures that there will be no radiation losses and no noise signals as a consequence of stray light penetrating the detection chamber. The measurement precision can thus be significantly increased. For the detection of the fluorescent signals, one detector or also a plurality of detectors can be used. As the detectors, for the example, a spectrometer, photocells with special filters or CCD cameras can be used. The detection chamber can be provided with reflective walls so that the fluorescent signals reflected from the walls can be indirectly picked up by a detector. Equipping the device with a plurality of detectors is however also possible and can be advantageous when fewer sensitive detectors are used or an especially rapid evaluation of the signal is required, as may be the case when there is a delay resulting from indirect acquisition of the fluorescent signals. Equipping the device with a shielded or reflective detection chamber is especially suitable for evacuation of information on objects in which the fluorescent dyestuffs have been applied in the form of dots, patterns, strips and other optically evaluatable geometric patterns or which have marked on the entire object with a certain fluorescent dyestuff, for example, in the form of a paint.

Through the use of a plurality of light sources and detectors over the internal surfaces of the detection chamber (roof, bottom, side surfaces of polygonal chambers or the interior of a spherical chamber) an especially rapid and defect-free evaluation of coded information which has been applied to positions on the object which are not readily accessible, can be carried out since a direct excitation with energy-rich light or a direct evaluaiton of the fluorescent signals around the object is here of special advantage. Within the detection chamber, the marked object its subjected to a light flash of a defined wavelength. Then the detection can be carried out with detectors on all sides of the emitted fluorescence signals. Depending upon the detected signals, a sorting can be effected by means of a sorting device and the article transported to the corresponding target location. With the aid of this “all around” evaluation, coded information on the objects can be evaluated especially well, regardless of the different forms in which information is encoded and independently of whether the information is located always at a previously determined position. With automatic sorting methods, objects can be transported by conveyors into the detector chamber in any optional position and evaluated.

In an advantageous embodiment of the invention the inner surfaces of the detection chamber are coated with a reflective coloring matter (for example TiO₂) or with the reflecting material (for example mirrors). As a consequence the light emitted from the light source or light sources is especially well distributed within the exterior of the detection chamber and thus illuminates the entire object all around the latter or so distributed that the fluorescence signals can be acquired by the detector.

The light sources and the detectors can be arranged, in an advantageous embodiment of the device, in a reading head as well. Under the term “reading head” a functional unit is to be understood which is comprised of a light source and detector with which the coded information on the articles can be evaluated. The reading head is brought into contact with the position on the article containing the coated information, for such evaluation, so that the light source can excite the fluorescence dyestuff-marked and/or the black-white bar code marked position for the fluorescence and signaling through the bar codes which are picked up by the detector, including the resulting fluorescence signal. As has already been described above, depending upon the requirement with respect to the wavelength spectrum for the fluorescence dyestuff and the black-white bar code, these can be excited or evaluated in the reading head with one or more light sources and the detectors arranged therein. The advantageous configuration of the device with a reading head enables the unit to have a relatively small size and to carry out the evaluation in a simple manner with higher reading speed and higher precision. The configuration of the device with a reading head is especially suitable for the evaluation of coded information in the form of bar codes provided by fluorescence dyestuffs since the different reflections of the fluorescent-coated bars can be evaluated with high precision and speed.

In an advantageous embodiment of the invention, the reading head has light guides for the emitted light and light guides for the fluorescent light. With the aid of these light guides, like for example glass fiber cables, the emitted light from the light source can be directly trained on the bar code. The measurement precision and measurement speed are thereby increased.

In an advantageous embodiment of the invention the reading head has a rubber collar which prevents the penetration of external light and the scattering of the signal to be measured. A higher measurement precision can thereby be obtained.

Through a synchronization in time, for example by electrical control, the light pulses and the detector can enable direct and specific evaluation of the signals. Thus for example the different fluorescent colors can be separated from one another in time of excitement and be evaluated subsequently by the detector like for example, a spectrometer, a photocell with a special filter, or a CCD camera.

The light sources of the device according to the invention should have an emission spectrum between 200 to 1800 nm. That makes it possible to excite a multiplicity of bar codes with light and to evaluate them. Information can be evaluated which is in the form of black-white bar codes, bar codes formed by fluorescent dyestuffs and marks formed by different fluorescent dyestuffs based upon differences in absorption characteristics and emission characteristics. The light sources can include spectral lamps, lasers, LEDs, infrared lamps, photo diodes or UV lamps.

1. A method of coding information on articles, characterized in that for coding the information a fluorescent dyestuff is used.

2. The method defined in claim 1, characterized in that a fluorescent dyestuff ifs used which fluoresces within 1 to 200 nanoseconds following excitation with energy-rich light.

3. The method according to claim 1, characterized in that the fluorescent dyestuff used emits light in the wavelength range of 300 to 1800 nm.

4. The method according to claim 1, characterized in that the following compounds, pyrene compounds, uranine, quinine, flurorescein, rhodamine, acridine orange, tetracycline, porphyrine is used.

5. The method according to claim 1, characterized in that different fluorescent dyestuffs are used simultaneously.

6. The method according to claim 1, characterized in that with the simultaneous use of different fluorescent dyestuffs, these differ only slightly in absorption characteristics but differ significantly in emission characteristics.

7. The method according to claim 1, characterized in that black-white bar codes and fluorescent dyestuffs are used for the coding of information.

8. The method according to claim 1, characterized in that the fluorescent dyestuff is applied in a diffused pattern to the article.

9. The method according to claim 1, characterized in that the fluorescent dyestuff is applied in the form of a bar code to the article.

10. The method according to claim 1, characterized in that the fluorescent dyestuff is applied by a printing process to the article.

11. The method according to claim 1, characterized in that a fluorescent dyestuff is used which does not fluoresce in the spectral range of 400 to 700 nm.

12. The method according to claim 1, characterized in that the fluorescent dyestuff is introduced during the manufacturing process of the material of the article and characterizes it.

13. A device for evaluating coded information which as been coded by means of a fluorescent dyestuff, comprising at least one light source and at least one detector, characterized in that the light source and detector are arranged in a reading head or a detection chamber and the device includes means for controlling the light emission.

14. The device according to claim 13, characterized in that the detection chamber is shielded against foreign light.

15. The device according to claim 13, characterized in that the light sources and detectors are distributed over the interior of the detection chamber.

16. The device according to claim 13, characterized in that the inner surfaces of the detection chamber are coated with reflecting color or are fabricated from reflected material.

17. The device according to claim 13, characterized in that the reading head is equipped with light guides for the emitted light and light guides for the fluorescent light.

18. The device according to claim 13, characterized in that the reading head has a rubber collar.

19. The device according to claim 13, characterized in that the light pulses are synchronized in time with the detector.

20. The device according to claim 13, characterized in that the light sources have a spectrum between 200 to 1800 nm.

21. The method of evaluating coded information which has been coded by means of a method according to claim 1.
